(19) United States
(12) Patent Application Publication
(10) Pub. No.: US 2024/0167958 A1
(43) Pub. Date: May 23, 2024

(54) METHOD AND SYSTEM FOR ACQUIRING CARS SPECTRUM

(71) Applicant: ATONARP INC., Minato-ku, Tokyo (JP)

(72) Inventor: Lukas BRUECKNER, Nieder-Olm (DE)

(73) Assignee: ATONARP INC., Minato-ku, Tokyo (JP)

(21) Appl. No.: 18/552,687

(22) PCT Filed: Apr. 21, 2022
(86) PCT No.: PCT/JP2022/018393

§ 371 Date: Sep. 27, 2023

Related U.S. Application Data
(60) Provisional application No. 63/178,232, filed on Apr. 22, 2021.

(51) Int. Cl. G01N 21/65

(52) U.S. Cl. CPC G01N 21/65; G01N 2021/653

(57) ABSTRACT

A system includes an optical path for irradiating a part of a target with pulses of Stokes light and pump light, and pulses of probe light with pulse widths larger than pulse widths of the pulses of the Stokes light and the pump light; a modulator that is configured to control relative temporal relationships between the pulses of the probe light and the pulses of the Stokes light and the pump light within the pulse width of the probe light; and a detector configured to detect CARS spectrum.

### TECHNICAL FIELD

The invention generally relates to a system and a method for acquiring CARS (Coherent Anti-Stokes Raman Scattering (Spectroscopy)) spectrum and/or spectra.

### BACKGROUND ART

In a publication US2010/0046039, a microscopy imaging system is disclosed that includes a first light source, a second light source, a modulator system, focusing optics, an optical detector, and a processor. The first light source is for providing a first train of pulses at a first center optical frequency ω1. The second light source is for providing a second train of pulses at a second center optical frequency ω2 such that a difference between ω1 and ω2 is resonant with a vibrational frequency of a sample in the focal volume. The second train of pulses is temporally synchronized with the first train of pulses. The modulator system is for modulating a beam property of the second train of pulses at a modulation frequency f of at least 100 kHz. The focusing optics is for directing and focusing the first train of pulses and the second train of pulses toward a common focal volume. The optical detector is for detecting an integrated intensity of substantially all optical frequency components of the first train of pulses transmitted or reflected through the common focal volume by blocking the second train of pulses being modulated. The processor is for detecting, at the modulation frequency f, a generated modulation of the integrated intensity of the substantially all of the optical frequency components of the first train of pulses due to the non-linear interaction of the first train of pulses with the second train of pulses in the common focal volume, to provide a pixel of an image for the microscopy imaging system.

### SUMMARY OF INVENTION

Raman microscopy has improved optical resolution and penetration depth as compared to infrared microscopy, but the sensitivity of Raman microscopy is rather poor. CARS microscopy, which uses two pulsed laser beams (pump and Stokes beams), significantly increases the absolute scattering signal due to the coherent excitation. The CARS process, however, also excites a high level of background from the vibrationally non-resonant specimen. Such a non-resonant background (NRB) not only distorts the CARS spectrum of the resonant signal from dilute sample but also carries the laser noise, significantly limiting the application of CARS microscopy on both spectroscopy and sensitivity perspectives.

Time-resolved coherent anti-Stokes Raman scattering, or Time-delayed coherent anti-Stokes Raman scattering (TD-CARS) microscopy which uses the probe light pulses in addition to the pulses of the Stokes light and the pump light, is also known as a technique for suppressing non-resonant background by utilizing the different temporal responses of virtual electronic transitions and Raman transitions. The probe light pulses have a delay to the pulses of the Stokes light and the pump light and the excitations due to the stokes pulses and the pump pulses light are followed by the probe pulses respectively. By the delayed probe pulses, the intensity of NRB can be eliminated but also the intensity of the resonant feature (resonant constituent) is reduced.

Quantitative analysis using CARS needs a reference. In order to get quantitative results, the MEM (Maximum Entropy Method) algorithm may be applied, but that needs multiple steps including changing the samples. MEM can also be done without reference, which however only works at high concentrations. At low concentrations or for best sensitivity, a reference under the same conditions is needed. That is, in addition to the sample measurement (e.g., glucose solution), the normalization procedure is required under the exact same conditions, however, for the normalization process, another cuvette filled with water is required that means the samples shall be changed, and the sensitivity and other conditions of the CARS optical system could be changed. There is a need for a system that can easily apply such measurement methods to various applications.

One of aspects of this invention is a method comprising: (i) acquiring first CARS spectrum by irradiating a part of a target with pulses of Stokes light and pump light, and pulses of probe light with pulse widths larger than pulse widths of the pulses of the Stokes light and the pump light, the Stokes light and the pump light being irradiated within the pulse width of the probe light; and (ii) acquiring second CARS spectrum as a reference to the first CARS spectrum by irradiating the part of the target with the pulses of the Stokes light, the pump light, and the probe light under same condition only varying temporal relationships between the pulses of the Stokes light and the pump light, and the pulses of the probe light to extract resonance constituents from the first CARS spectrum.

According to the findings of the inventor's simulation, NRB (Non-Resonant Background) is an instantaneous electronic response, and the resonant feature requires slower build-up, and long decay time also requires longer buildup (narrow linewidths) and shorter decay times requires shorter time for response buildup (broader linewidths). That is, by the pulses of the probe light with the broader or wider pulse widths in time for getting CARS response signals and by just (only) changing the temporal relationship between the pulses of the probe light and the pulses of the Stokes light and the pump light for exciting the vibrations of target molecules, sets of CARS spectrum including the first CARS spectrum with both the resonance feature and the non-resonance feature and the second CARS spectrum with almost purely non-resonant feature or the non-resonance feature with a smaller amount of the resonance feature, which is sufficient as a reference of non-resonant feature, are acquired. Therefore, the reference spectrum for quantitative analysis can be obtained as the second CARS spectrum only by changing the temporal relationship of the pulses of the Stokes light and the pump light and the pulses of the probe light without changing the target (target sample) such as cuvette. This can significantly improve the accuracy of trace analysis using CARS and, for the non-invasive analysis, the reference spectrum can get from a living subject itself.

The step of acquiring first CARS spectrum may include emitting the pulses of the probe light with a first relative temporal relationship to the pulses of the Stokes light and the pump light to overlap within the pulse width of the pulses of the probe light, and the step of acquiring second CARS spectrum may include emitting the pulses of the probe light with a second relative temporal relationship, which has a negative delay relative to the first relative temporal relationship, to the pulses of the Stokes light and the pump light to overlap within the pulse width of the pluses of the probe light. Whereas the delayed probe pulses, which have a positive delay, are used to obtain TD-CARS spectrums, in this method an inverse delayed probe pulses, which have a negative delay, can be used, thereby obtaining the reference spectrums with no or little resonance.

The step of acquiring second CARS spectrum may include emitting the pulses of the probe light earlier than the pulses of Stokes light and the pump light. That is, the pulses of the probe light may be followed by the pulses of Stokes light and the pump light for exciting. Typically, the step of acquiring first CARS spectrum may include emitting the pulses of the Stokes light, the pump light and the probe light at effectively the same time, and the step of acquiring second CARS spectrum may include emitting the pulses of the Stokes light and the pump light at effectively the end of the pulse width the pulses of the probe light.

The method may further include scanning the target with the Stokes light, the pump light, and the probe light to acquire the first CARS spectrum and the second CARS spectrum at each pixel for performing 2D CARS microscopy imaging. The method may further include scanning the target with the Stokes light, the pump light, and the probe light in three dimensions to acquire the first CARS spectrum and the second CARS spectrum at each voxel for performing 3D CARS microscopy imaging.

One of other aspects of this invention is a method comprising: (i) acquiring sets of CARS spectrum by irradiating a part of a target with pulses of Stokes light and pump light, and pulses of probe light with pulse widths larger than pulse widths of the pulses of the Stokes light and the pump light, just varying temporal relationship between the pulses of the Stokes light and the pump light, and the pulses of the probe light to overlap within the pulse widths of the pulses of the probe light; and (ii) extracting resonance constituents by comparing the sets of CARS spectrum acquired. The step of acquiring sets of CARS spectrum may include irradiating the part of the target with the pulses of the probe light with a negative delay (invers delay) to the pulses of the Stokes light and the pump light.

Yet one of other aspects of this invention is a system comprising: (i) an optical path configured to irradiate a part of a target with pulses of Stokes light and pump light, and pulses of probe light with pulse widths larger than pulse widths of the pulses of the Stokes light and the pump light; (ii) a modulator configured to control relative temporal relationships between the pulses of the probe light and the pulses of the Stokes light and the pump light within the pulse width of the probe light; and (iii) a detector configured to detect CARS spectrum generated by the pulses of the Stokes light, the pump light, and the probe light to acquire sets of CARS spectrum in association with the relative temporal relationships.

Yet one of other aspects of this invention is a computer program or computer program product stored in a non-transitory medium for a computer to operate the system described above. The computer program (program product) includes an instruction for controlling the relative temporal relationships to irradiate the target with the pulses of the probe light with a negative delay to the pulses of the Stokes light and the pump light. The program may include instructions for controlling the modulator to set the relative temporal relationships to irradiate the target with the pulses of the probe light with a negative delay to the pulses of the Stokes light and the pump light. The program may include instructions for controlling the modulator to set the relative temporal relationships to emit the pulses of the probe light earlier than the pulses of Stokes light and the pump light.

### BRIEF DESCRIPTION OF DRAWINGS

The embodiments herein will be better understood from the following detailed description with reference to the drawings, in which:

FIG. 1 depicts an embodiment of a system of this invention;

FIG. 2 depicts a typical CARS spectrum;

FIG. 3 depicts examples of CARS spectrum when the delays of the probe light are varied;

FIG. 4 depicts an example of analyzing method using the MEM algorithm;

FIG. 5 depicts examples of CARS measurement and internal reference measurement;

FIG. 6 depicts an outline of internal reference method;

FIG. 7 depicts an outline of normalizing method;

FIG. 8 depicts examples of results using the internal reference method;

FIG. 9 depicts other examples of results using the internal reference method;

FIG. 10 depicts a diagram of another example of the modulator;

FIG. 11 depicts a flow diagram of internal reference method.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

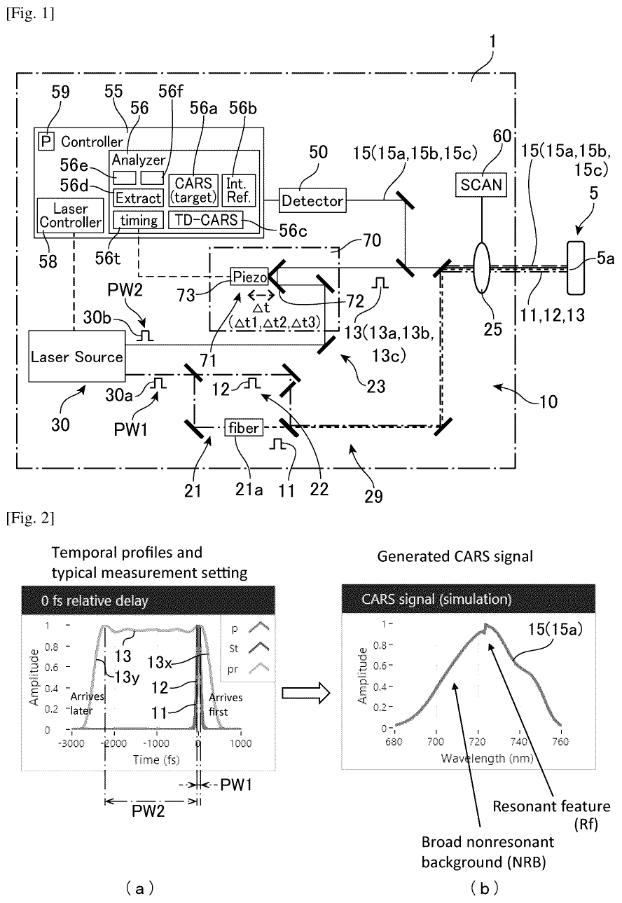

FIG. 1 illustrates a system 1 according to an embodiment of this invention. The system 1 comprises an optical module 10 that is configured to supply (emit) pulses of Stokes light 11, pump light 12 and probe light 13 for irradiating a part 5a of a target 5 to generate CARS (Coherent Anti-Stokes Raman Scattering or Coherent Anti-Stokes Raman Spectroscopy) signals (CARS spectrums, CARS lights) 15 on the part 5a of the target (object, sample) 5. This system 1 can be used as a measurement device, analyzer, monitoring device, monitor and others depending on the applications. The optical system 10 uses CARS to acquire data indicative of surface and internal conditions and components of a target 5, such as samples in a cuvette or a human body.

The system further comprises a scanner (scanning interface) 60 that is configured to scan the target 5 with the Stokes light 11, the pump light 12 and the probe light 13 and acquire the CARS light 15 from the target 5 through a lens 25 and other optical elements; a modulator 70 that is configured to control relative temporal relationships of the pulses of the probe light 13 to the pulses of the Stokes light 11 and the pump light 12; a detector 50 that is configured to detect the CARS light 15 for analyzing; and a controller 55 that is configured to control the system 1 and the modules such as the scanner 60, the modulator 70, a laser source 30. The scanning module 60 may be a cuvette, a non-invasive sampler, an invasive sampler, a flow path, or a wearable scanning interface such as a fingertip scanning interface module. The controller 55 includes a laser controller 58 that controls the laser source 30, and an analyzer 56 that analyzes internal compositions (components) by CARS (CARS spectrum). The analyzer 56 may include multiple modules 56a-56d to verify the part 5a of target 5 at which the CARS light 15 is generated. A program (program produce, software, application) 59 stored in the memory of the controller 55 is provided for running the process on the controller 55 with computer resources such as the memory, CPU, and others. The program (software) 59 may be provided as other memory medium (non-transitory medium) readable by a processor or a computer.

The optical system 10 includes a laser source 30 for generating first laser pulses 30a with a first wavelength 1040 nm for the Stokes light (Stokes beam pulses, first light pulses) 11 and the pump light (pump beam pulses, second light pulses) 12. One of the preferable laser sources 30 is a fiber laser. The first laser pulses 30a have one to several hundred fs (femtosecond)-order pulse widths with tens to hundreds of mW to generate pulses of the Stokes light 11 and the pump light 12 with femtosecond-order pulse widths. Pulse widths PW1 of the pulses of the Stokes light 11 and the pump light 12 may be one to several hundred such as 1-900 fs, or may be 10-600 fs, or may be 50-400 fs. The optical system 10 includes a plurality of optical elements 29 such as lenses, filters, mirrors, dichroic mirrors and prisms for arranging optical paths to separate and combine the leaser light pulses.

The optical system 10 includes a Stokes light path (first optical path, Stokes unit) 21 that is configured to supply the broadband Stokes light pulses (first light pulses) 11 with a first range R1 of wavelengths 1080-1300 nm from the first laser pulses 30a which are common to the pump light pulses 12, through the PCF (Photonic Crystal Fiber, fiber) 21a. The optical system 10 includes a pump light path (second optical path, pump unit) 22 that is configured to supply the pump light pulses (second light pulses) 12 with a second range R2 of wavelengths 1070 nm that is shorter than the first wavelength range (first range) R1 from the first laser pulses 30a which is common to the Stokes light 11. The optical system 10 includes a common optical path that supplies the Stokes light pulses 11 provided by the path 21 and the pump light pulses 12 provided by path 22 to the optical I/O unit (lens system) 25. The optical paths include necessary optical elements such as filters, fibers, dichroic mirrors and prisms to configure each optical path. The same applies to the optical paths described below.

The laser source 30 generates, in addition to the first laser pulse 30a with a first wavelength 1040 nm for the Stokes light pulses 11 and the pump light pulses 12, a second laser pulses 30b with a second wavelength 780 nm for the probe light pulses (probe beam, third light pulses) 13. The second laser pulses 30b may include one to several tens ps (picosecond)-order pulses with tens to hundreds of mW to generate pulses of the probe light 13 with picosecond order pulse widths. Pulse widths PW2 of the pulses of the probe light 13 may be one to several tens such as 1-90 ps, or may be 1-50 ps, or may be 2-10 ps. The second laser pulses 30b with the wavelength of 780 nm may be generated from the source oscillator with a wavelength of 1560 nm. The optical system 10 includes, in addition to the Stokes light path 21 and the pump light path 22, a probe light path (third optical path, probe unit) 23 that is configured to supply the probe light pulses (probe beam pulses, probe pulse, third light pulses) 13 with a third range R3 of wavelength of 780 nm that is shorter than the second wavelength range R2.

The optical system 10 further includes the optical I/O unit (optical unit) 25 that is configured to coaxially output the Stokes light pulses 11, the pump light pulses 12 and the probe light pulses 13 to the target 5 and acquire a CARS light 15 from the target 5 via a common light path. A typical optical I/O unit 25 is an objective lens or lens system that faces to the target 5 and gets backward CARS light pulses (Epi-CARS) 15. The optical system 10 may include an optical path configured to get forward CARS light. In this system 10, the CARS light pulses 15 with a range of wavelengths of 680-760 nm that is shorter than the wavelength range R3 is generated by the probe light pulses 13 and acquired to be detected by the detector 50.

The optical system 10 includes a modulator (modulating unit, time delay unit) 70 that is configured to control relative temporal relationships between the pulses of the probe light 13 and the pulses of the Stokes light 11 and the pump light 12 within the pulse width PW2 of the probe light 13. Typically, the modulator controls (varies, sets, or modulates) a time difference Δt between emissions of the probe light pulses 13 and emissions of the Stokes light pulses 11 and the pump light pulses 12. The modulator includes a time delay stage (time delay unit) 71 may include a collimator 72 and an actuator 73 such as a motor or a piezo that can modulate a light path (a length of light path) of the probe light pulses 13. The modulator 70 may include an LC-SLM (Liquid crystal spatial light modulator), an AWG (Arrayed wave-guide grating) and others control the distance between the collimators. The modulator 70 may control the light paths of the Stokes light 11 and the pump light 12 in addition to, or instead of the light path of the probe light 13.

The relative temporal relationships between the pulses of the probe light 13 and the pulses of the Stokes light 11 and the pump light 12 (time difference, time delay) Δts of the modulator 70 may be varied or set under the control of the timing controller 56t in the controller 55. By using the modulator 70, the probe light path 23 may supply typically three kinds (types) of the probe light pulses 13a, 13b and 13c with different time differences Δts from/to the emitting the Stokes light pulses 11 and the pump light pulses 12 for irradiating at the point 5a of the target 5 via the optical I/O unit 25 to get typically three kinds (types) of CARS pulses 15a, 15b and 15c with different temporal relationships Δts that are delayed minus (negative) few 1000 fs (few picoseconds) to 0 to plus (positive) few 1000 fs (few picoseconds) or more from/to the excitation by the pluses of the Stokes light 11 and the pump light 12.

The controller 55 further includes, corresponding to the three kinds of modes, a target CARS spectrum acquisition module (target CARS acquisition module, target CARS acquisitor) 56a, a reference CARS acquisition module (internal reference acquisition module, internal reference acquisitor) 56b and a TD-CARS acquisition module (TD-CARS acquisitor) 56c. The target CARS acquisition module 56a controls the modulator 70 via the timing module 56t to acquire the first CARS spectrum (target CARS spectrum) 15a by irradiating a part 5a of a target 5 with the pulses of Stokes light 11 and pump light 12, and the pulses of probe light 13a with pulse widths PW2 that is larger than pulse widths PW1 of the pulses of the Stokes light 11 and the pump light 12. The target CARS acquisition module 56a gets the CARS spectrum 15a by irradiating the target 5 with the Stokes light 11, the pump light 12 within the pulse width PW2 of the probe light 13, typically by irradiating the target 5 with the Stokes light 11, the pump light 12 and the probe light 13a at effectively the same time without a time difference (without delay).

The internal reference acquisition module 56b controls the modulator 70 via the timing module 56t to acquire the second CARS spectrum (internal reference CARS spectrum, internal reference) 15b by irradiating a part 5a of a target 5 with the pulses of the Stokes light 11, the pump light 12, and the probe light 13b under same condition only varying temporal relationships Δts between the pulses of the Stokes light 11 and the pump light 12, and the pulses of the probe light 13 within the pulse widths PW2 to extract resonance constituents (resonant features) Rf from the target CARS spectrum 15a. That is, the target CARS acquisition module 56a generates the target CARS spectrums (first CARS spectrums) by using the modulator 70 to emit the pulses of the probe light 13a with the first relative temporal relationship (first delay, first time-delay) Δt1 to the emission of the pulses of the Stokes light 11 and the pump light 12 to overlap within the pulse width PW2 of the pulses of the probe light 13, and the internal reference acquisition module 56b generates the internal reference spectrums (second CARS spectrums) 15b by using the modulator 70 to emit the pulses of the probe light 13b with a second relative temporal relationship (second delay, second time-delay) Δt2 which has a negative delay (inverse delay) relative to the first delay Δt1 to the emission of the pulses of the Stokes light 11 and the pump light 12 but to still overlap within the pulse width PW2 of the pluses of the probe light 13a. Hence, the internal reference acquisition module 56b controls the modulator 70 to emit the pulses of the probe light 13b earlier than the pulses of Stokes light 11 and the pump light 12.

Typically, the target CARS acquisition module 56a controls the modulator 70 to emit the pulses of the Stokes light 11, the pump light 12 and the probe light 13a at effectively the same time, that is the first delay Δt1 is 0 (zero) or substantially zero, and the internal reference acquisition module 56b controls the modulator 70 to emit the pulses of the Stokes light 11 and the pump light 12 at effectively the end of the pulse width PW2 of the pulses of the probe light 13b, that is the second delay Δt2 equals PW2 or substantially equals PW2.

The TD-CARS acquisition module 56c controls the modulator 70 via the timing module 56t to acquire the TD-CARS spectrums 15c by irradiating a part 5a of a target 5 with the pulses of the Stokes light 11, the pump light 12, and the probe light 13c with a third relative temporal relationship (third delay) Δt3 which has a positive delay relative to the first delay Δt1 to the emission of the pulses of the Stokes light 11 and the pump light 12, hence the pulses of the Stokes light 11 and the pump light 12, and the pulses of probe light 13c do not substantially overlap each other.

The detector 50 is configured to detect CARS spectrum 15a, 15b and 15c generated by the pulses of the Stokes light 11, the pump light 12, and the probe light 13a, 13b and 13c to acquire sets of CARS spectrum 15 including spectrums 15a, 15b and 15c in association with the relative temporal relationships Δt1, Δt2 and Δt3. The sets of CARS spectrum 15 may include the target CARS spectrums 15a and the internal references 15b to extract the resonance constituents Rf from the target CARS spectrums 15a by referring to or compering (normalizing, subtracting) the internal references 15b.

The controller 55 may further includes an extraction module (extractor) 56d configured to extract the resonance constituents (resonant features) Rf from the target CARS spectrums 15a by referring to the internal references 15b to analyze the features or compositions of the part 5a of the target 5. The extraction module 56d may include the functions of scanning the target 5 by using the scanner 60. The scanner 60 that is configured to scan the target 5 with the Stokes light 11, the pump light 12, and the probe light 13a and 13b to acquire the sets of CARS spectrum 15 including the target CARS spectrums 15a and the internal references 15b at each pixel. The analyzer 55 may include an image generation module (image generator) 56e that generates images (2D images) of the target 5 by the pixels having the resonant features Rf. Accordingly, the system 1 may have the functions of CARS spectroscopy and CARS microscopy.

In CARS spectroscopy, by moving the focus or spot of the Stokes light 11, the pump light 12, and the probe light 13, the system 1 can generates the depth profile of the target 5. Hence, the scanner 60 may be configured to scan the target 5 with the Stokes light 11, the pump light 12, and the probe light 13a and 13b in three dimensions to acquire the sets of CARS spectrum 15 including the target CARS spectrums 15a and the internal references 15b at each voxel. The analyzer 55 may include a 3D image generation module (3D image generator) 56f that generates 3D images of the target 5 by the voxels having the resonant features Rf. Accordingly, the system 1 may have the functions of CARS 3D microscopy.

By using a broadband Stokes pulses (Stokes beam) 11, one can excite many resonances at once and record a full spectrum in one shot. Therefore, by scanning the target (sample) 5, a full CARS spectrums 15a and 15b can be provided at each pixel or voxel by each shot to make the 2D or 3D CARS imaging in a short time. In addition, by using the system 1 one records an internal non-resonant reference 15b at each pixel or voxel in addition to the normal CARS signal 15a from the actual measurement position in the target 5 including tissue and the like. Since differences in generation, optical path, scattering, sample heterogeneity, and other artifacts are cancelled out, the CARS spectrums (spectra) with boosted sensitivity are generated by the system 1.

FIG. 2 shows typical CARS spectrum (light, signals, spectrum, spectra) including the broad non-resonant background (NRB) and a Resonant feature (Rf) (FIG. 2 (b)), generated by the pulses of the Stokes light 11, the pump light 12 and the probe light 13 with the time delay Δt1 (0 fs) (FIG. 2(a)), that is, the Stokes pulse 11, the pump pulse 12 and the probe pulse 13 are emitted at the same time and the time delay feature (compositions, constituent) of CARS signal 15 is acquired within the pulse width PW2 of the Probe light pulses 13. The Stokes pulse 11 and the pump pulse 11 are overlap in time and the position of the probe pulse 13 can be controlled. The difference in time (temporal relationship, time delay) Δt between the pulses of the Stokes light 11 and the pump light 12 and the probe pulse 13 is chosen arbitrarily. In FIG. 2 (a), the time delay Δt is set to Δt1 (t=0), that is, the Stokes pulse 11 and the pump pulse 12 are overlap with the start (arrives first) 13x of the probe pulse 13, after that the rest of the probe pulse 13 arrives later including the end (arrives the latest) 13y.

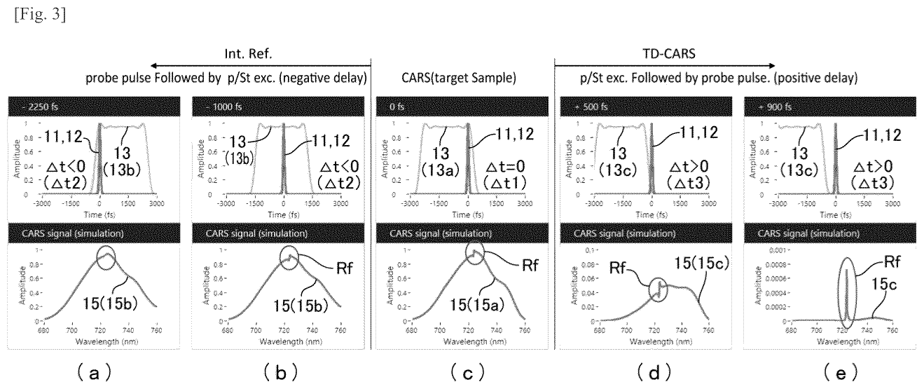

FIG. 3 shows the sets of CARS lights (signals, spectrum, spectra) 15 as the simulation results when the delays (temporal relationships) Δts of the probe light 13 are changed. FIG. 3(c) shows an example of the target CARS spectrums 15a generated by the Stokes pulse 11, the pump pulse 12 and the probe pulse 13a emitted at the same time (the time delay Δt is set to Δt1 (Δt=0)). FIGS. 3(a) and 3(b) show examples of the internal references 15b generated by the Stokes pulse 11 and the pump pulse 12, and the probe pulse 13b with the negative delay Δt2. That is the Stokes pulse 11 and the pump pulse 12 are emitted later than the emission of the probe pulse 13b but to overlap with the probe pulse 13b. Typical internal reference 15b is acquired as shown in FIG. 3(a) when the Stokes pulse 11 and the pump pulse 12 are emitted to overlap with the end of the probe pulse 13b.

FIGS. 3(d) and 3(e) show examples of the TD-CARS spectrums 15c generated by the Stokes pulse 11 and the pump pulse 12, and the probe pulse 13c with the positive delay Δt3. That is the probe pulse 13c is emitted later than the emission of the Stokes pulse 11 and the pump pulse 12 so as the probe pulse 13c does not overlap with the Stokes pulse 11 and the pump pulse 12. Typical TD-CARS 15c is acquired as shown in FIG. 3(e) that is formed almost exclusively of resonance components (resonance constituent, resonant feature) Rf, but has very small intensity compared to the target CARS spectrums 15a and the internal references 15b.

As are shown in FIGS. 3(a) to 3(e), the phenomena such as molecular vibration changes with long decay time, which are corresponding to resonant feature (Rf), require longer buildup, and the phenomena such as molecular vibration changes with shorter decay time, which are corresponding to NRB, require shorter time for buildup. That is, NRB is an instantaneous electronic response. Resonant feature (Rf) is slower build-up, and the same trend is shown in the simulation results of TD-CARS. Long decay time also requires longer buildup (narrow linewidths) and shorter decay times require shorter time for response buildup (broader linewidths). Therefore, the CARS spectrum 15a with larger resonant features with NRB is acquired when emitting the probe pulse 13a at the same time with the Stokes pulse 11 and the pump pulse 12, and the internal reference 15b that is the CARS spectrum with almost NRB (In this specification, a spectrum containing mostly or exclusively NRB indicates a spectrum that does not contain resonance components to a sufficient degree to serve as a reference for NRB) is acquired when emitting the Stokes pulse 11 and the pump pulse 12 at the end of pulse width PW2 of the Probe pulse 13b.

When emitting the probe light 13c without overlapping with the Stokes pulse 11 and the pump pulse 12, TD-CARS light (spectrum) 15c which has relatively large resonant features but in which the intensity of signals is so small is acquired. That is, the TD-CARS spectrum 15c does not only have resonant features but the ratio of resonant to non-resonant contributions is increased. When the delay becomes large, the TD-CARS spectrum 15c with almost only resonant contributions is acquired. This is because of different decay times. Non-resonant signal decays very quickly after the excitation (pump 12 and Stokes 11) and resonant features usually decay more slowly (depending on linewidth of the resonance) so that basically more resonant signal is left relative to the non-resonant when the probe 13 arrives.

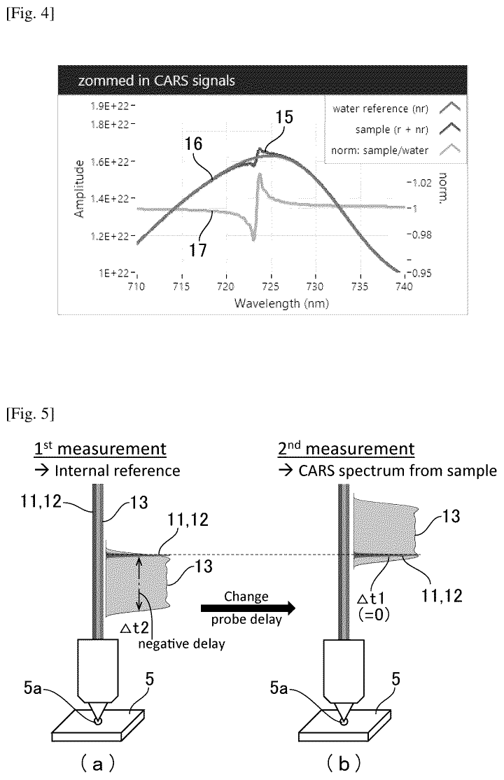

FIG. 4 shows an example of a method (algorithm) of quantitative analysis using CARS spectrum. For conventional quantitative analysis, the reference spectrum 16 such as the spectrum of water is required for estimating the norm 17 of sample/water and when switching the cuvettes, some detecting conditions could be changed that may cause degrading sensitivity of the quantitative analysis. In order to get quantitative results, the MEM (Maximum Entropy Method) algorithm is applied, and the first step is the normalization procedure that includes two measurements: (a) sample measurement (e.g., glucose solution) and (b) normalizing with a water measurement under the exact same conditions. That needs to change the samples. Since sensitivity relies on absolutely stable conditions, any change in spectrum etc. will limit sensitivity. Using the same cuvette for both water and sample is possible but inconvenient, and furthermore, changing cuvettes is itself a factor that poses a limit to sensitivity.

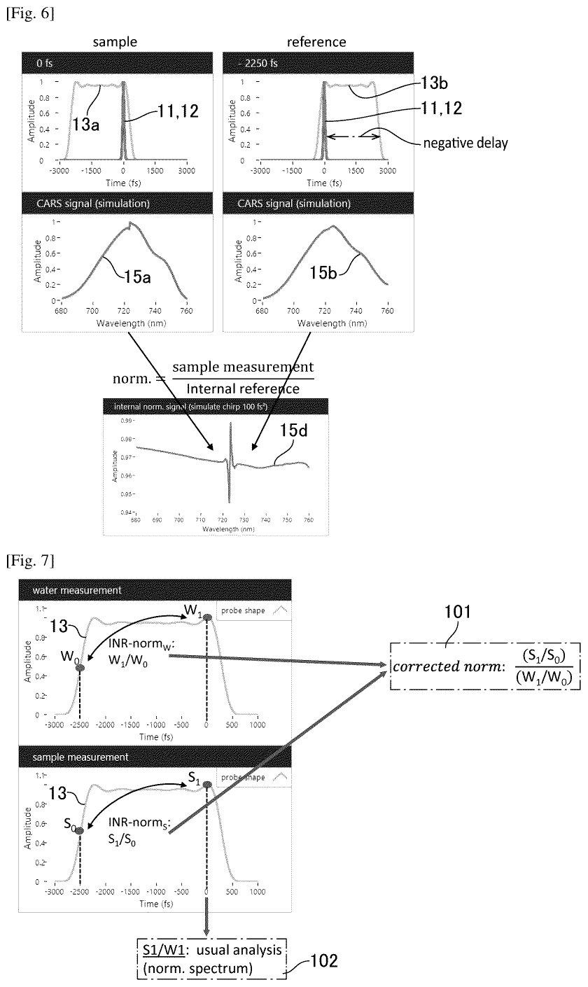

FIG. 5 and FIG. 6 show a basic of the Internal reference technique (method) of this application. As is shown in FIG. 5, by varying the temporal relationships Δts of the Probe pulses 13 to the Stokes pulses 11 and the pump pulses 12, the CARS spectrum 15a with the resonant features with NRB (FIG. 5(b)) and the CARS spectrum 15b with NRB only (FIG. 5(a)) can be acquired without changing the samples and the cuvettes under the exact same experimental conditions (focus, scattering, absorption, optical path, etc.).

As is shown in FIG. 6, the CARS spectrum 15a with the resonant features with NRB is acquired by the probe pulse 13a without delay and the CARS spectrum 15b with NRB only is acquired by the probe pulse 13b with a negative delay without changing the samples and the cuvettes. By using the CARS spectrum 15b with NRB only as the reference signal (internal reference), the CARS spectrum 15d including resonant features only can be delivered. The internal reference spectrum 15b is subject to the same experimental conditions like absorption, signal path, and others that show the same fine structure as the sample measurement and water reference redundant, especially for high and medium concentration. In addition, this internal reference method is applicable to forward and backscattered CARS. In this method, water reference may be redundant for high/medium concentration samples, but as correction factor, a one-time water measurement may improve results. Multiple options for implementation (e.g., kHz switching to track even quick changes in signal) are possible.

FIG. 7 shows an example of calculation and correction using non-resonant INR (INternal Reference) at low concentrations. The upper figure shows an example of water measurement for correction and the lower figure shows an example of sample measurement. Conventionally, for normalizing the sample spectrum by the water spectrum, the correction of the format 102 should be applied. But in this method, correction can be done by using the format 101. Since same spectral changes due to probe movement in sample and water measurement, changes can be normalized using the format 101, that is, water (non-resonant sample) and sample measurement can be done under totally different conditions. It should be noted that the only purpose of water measurement is to get the spectral changes.

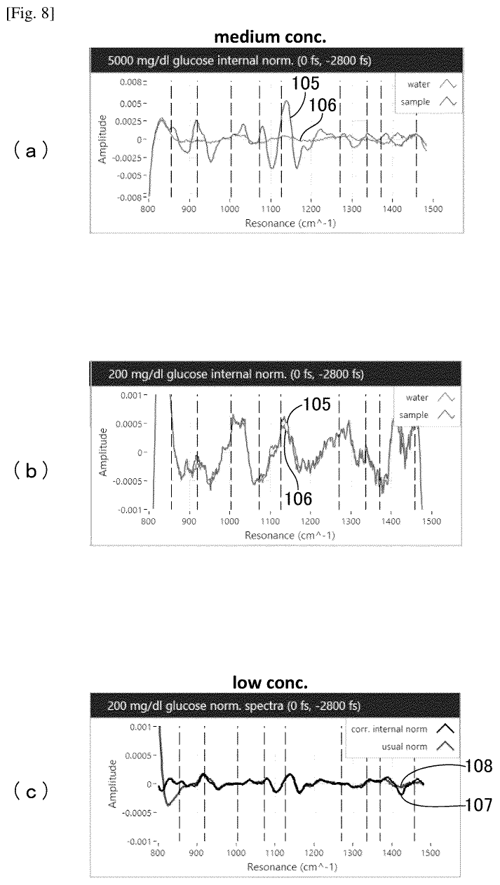

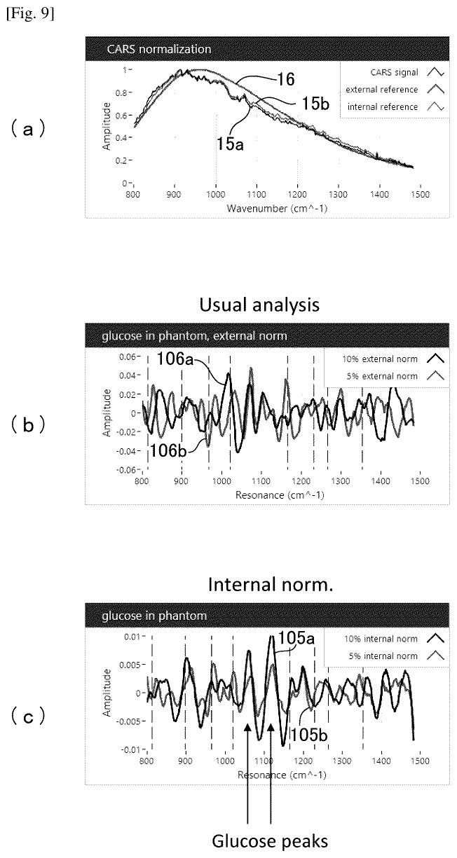

FIGS. 8 and 9 show experimental results applying the internal reference method disclosed in this application. FIG. 8 shows CARS spectrum with glucose constituents retrieved using the internal reference spectrum without using the cuvette for water reference. FIG. 8(a) shows an example of CARS spectrum 105 of 5000 mg/dl glucose solution that is derived (extracted) using the CARS spectrum 15a without delay and the internal reference 15b with a negative delay (−2800 fs). FIG. 8(a) shows an example of CARS spectrum 106 of water for reference. FIG. 8(b) shows an example of CARS spectrum 105 of 200 mg/dl glucose solution that is derived using the CARS spectrum 15a without delay and the internal reference 15b with a negative delay (−2800 fs). In FIG. 8(b), CARS spectrum 106 of water is shown for reference as well. FIG. 8(c) shows an example of CARS spectrum 107 of 200 mg/dl glucose solution that is normalize (corrected) CARS spectrum 105 in FIG. 8(b) using the CARS spectrum of water as described in FIG. 7. In FIG. 8(c), normalized CARS spectrum 108 using conventional method is shown as a reference. For the solution with high and medium concentrations of glucose, the CARS spectrum with the resonant feature corresponding to the concentration of glucose may be delivered (retrieved) without need for water reference. For the solution with a low concentration of glucose, a small difference in the excitation spectrum is observed and one-time external reference may be required.

FIG. 9 shows examples of the results of backward (Epi) CARS measurement. When using the water reference according to the prior method, noises included in the CARS spectrum are increased due to much lower signal intensity compared to forward CARS signal and Epi-CARS spectrum includes higher noise and more artifacts, which makes it hard to use quantitative analysis. But, using the internal reference method described above, the noises due to lower signal intensity can be depressed and Epi-CARS spectrum including sharper peaks of resonant features can be delivered. FIG. 9(a) shows an example of Epi-CARS spectrum 15a without delay, an example of Epi-internal reference 15b with a negative delay, and an example of Epi-CARS spectrum 16 of external reference (water). FIG. 9(b) shows examples of normalized Epi-CARS spectrums for 10% glucose concentration (106a) and 5% glucose concentration (106b) using the external reference (conventional method). FIG. 9(c) shows examples of normalized Epi-CARS spectrums for 10% glucose concentration (105a) and 5% glucose concentration (105b) using the internal reference as described in this application (conventional method). By using the internal reference method, the Epi-CARS spectrums having glucose peaks corresponding to the concentration are delivered.

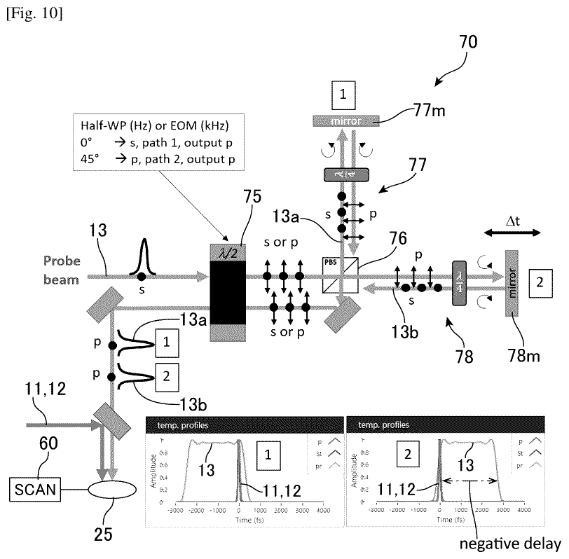

FIG. 10 illustrates another embodiment of the modulator 70. The modulator 70 includes: a waveplate 75 for converting polarization of input probe pulses 13; a PBS 76 for separating the first probe pulses (for example p-pol light) 13a and the second probe pulses (for example s-pol light) 13b from the input probe pulses 13; a first probe path 77 for conditioning the first probe pluses 13a, which includes a waveplate and a mirror 77m for reflecting the first probe pulses 13a to the PBS 76; and a second probe path 78 for conditioning the second probe pluses 13b including the time difference Δt to the first probe pulses 13a (to the Stokes pulses 11 and the pump pulses 12), which includes a waveplate, a mirror 78m for reflecting the second probe pluses 13b to the PBS 76. The second probe path 78 may include an actuator to move the mirror 78m for controlling the delay Δt. The waveplate 75 may be an EOM (Electro-Optic Modulator) that can control or select the probe pulses 13a and 13b fed through by its polarizations electrically. Since the modulator 70 using a translation stage that travels a distance corresponding to the desired probe delay change, the modulating speed is relatively slow, and repeatability of position may not exact. By replacing a translation stage with polarization optic, the modulator 70 with fast repeatable modulation can be provided. This modulator 70 includes the two pathways 77 and 78 with adjustable relative delay selected by polarization. Waveplate 75 may be a rotation stage or Electro optic modulator (EOM) for fast (>kHz) modulation. Fast modulation promises reduced noise, removing drift of power, alignment, potential etaloning etc., and increasing scanning speed for generating CARS images.

By focusing the laser light on a sample, for example a liquid solution in a cuvette, the CARS spectrum is generated so that it can be analyzed to identify different molecules or even be quantitative to determine concentrations of a solution. In contrast to other methods like fluorescence or Raman spectroscopy, in CARS and other nonlinear methods, the signal is only generated at the focus position. At high focusing, intrinsic spatial resolution is achieved, and the signal is generated only from a tiny volume in the order of 1 μm³. Instead of measuring liquid solutions in a cuvette, however, one can directly apply CARS to structured materials like tissue. The system 1 can scan over the samples by the beam 11, 12 and 13 to provide a spectrum at each different position, which make it possible to generate an image. The system 1 can be applied as a CARS spectroscopy also as a CARS microscopy by scanning and getting a spectrum at each pixel to form an image. For thin samples (targets) 5, signals can be recorded in forward direction through the sample or in back-scattered direction for thicker samples. Imaging requires high local concentrations like lipids in a fat cell, for example. By focusing on a small volume containing high local concentrations, peaks stand out from the background. A non-resonant reference measurement can be taken from water outside or the glass cover slip on the tissue sample. This works for high local concentrations only and samples showing minimal scattering and other artifacts so that the spectral shape between reference and sample is somewhat constant (e.g., in a very thin sample measured in forward direction). In more complex samples (back-scattered, thicker, highly scattering) the overall spectral shape changes due to heterogeneity of the tissue and sensitivity is very limited.

When using the proposed internal reference method, one records an internal non-resonant reference at each pixel or voxel in addition to the normal CARS signal from the actual measurement position in the tissue. By the internal reference method of this application, differences in generation, optical path, scattering, sample heterogeneity, and other artifacts are cancelled out, hence the sensitivity of CARS microscopy can be greatly improved.

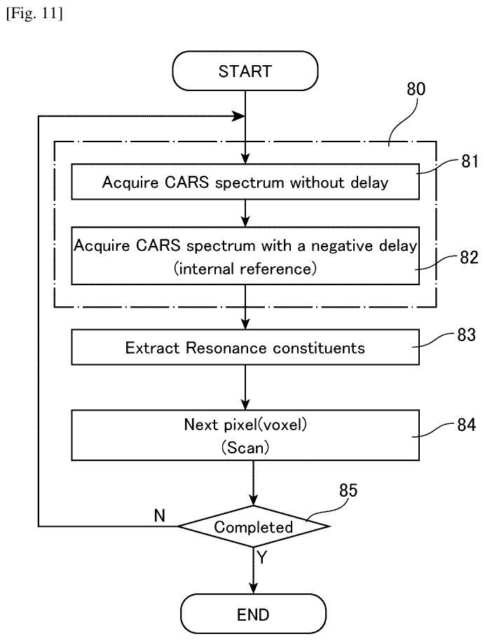

FIG. 11 is a flow diagram showing an overview of the process of the internal reference method. The method includes acquiring sets of CARS spectrum (step 80) and extracting resonance constituents (resonance components, resonant features) by comparing the sets of CARS spectrum acquired (step 83). In step 80, the sets of CARS spectrum 15 are acquired by irradiating a part 5a of a target 5 with pulses of Stokes light 11 and pump light 12, and pulses of probe light 13 with pulse widths PW2 larger than pulse widths PW1 of the pulses of the Stokes light 11 and the pump light 12, just varying temporal relationship Δt between the pulses of the Stokes light 11 and the pump light 12, and the pulses of the probe light 13 to overlap within the pulse widths PW2 of the pulses of the probe light 13.

The step 80 may include a step 81 for acquiring first CARS spectrums 15a and a step 82 for acquiring second CARS spectrums 15b as the internal references. In the step 81, the CARS spectrums 15a are generated and acquired by irradiating a part 5a of a target (sample) 5 with pulses of Stokes light 11 and pump light 12, and pulses of probe light 13 with pulse widths PW2 larger than pulse widths PW1 of the pulses of the Stokes light 11 and the pump light 12. The Stokes light 11 and the pump light 12 are irradiated within the pulse width PW2 of the probe light 13. Typically, the pulses of the Stokes light 11, the pump light 12, and the probe light 13 are emitted without delay (Δt=0). In the step 82, the internal references 15b are acquired by irradiating the part 5a of the target 5 with the pulses of the Stokes light 11, the pump light 12, and the probe light 13 under same condition only varying temporal relationships (time difference, delay) Δt between the pulses of the Stokes light 11 and the pump light 12, and the pulses of the probe light 13 to extract resonance constituents from the first CARS spectrum 15a. Typically the internal references 15b are acquired with the negative delay (Δt<0).

The method may further include a step of scanning the target 5 (step 84). In the step 84, the target 5 is scanned with the Stokes light 11, the pump light 12, and the probe light 13 to acquire the first CARS spectrum 15a and the internal reference (second CARS spectrum) 15b at each pixel to generate an image of the target 5. The step 84 may be the 3D scanning to acquire the first CARS spectrum 15a and the internal reference (second CARS spectrum) 15b at each voxel to generate a 3D image of the target 5. In step 85, the above steps may be repeated until all pixel information is obtained.

As described in this specification, the probe delay is used to control the amount of resonant contribution in the generated CARS signal. Using positive time-delay (probe arrives after pump+Stokes) is known and applied for generating TD-CARS 15c. The effect of using negative probe delay (probe arrives before p/St, temporal overlap only at the very end of the pulse), however, opens totally new opportunities for CARS spectroscopy and microscopy. Positive probe delay enhances the resonant to non-resonant ratio at the cost of total signal intensity. Negative delay reduces the (resonant/non-resonant) ratio to a point where the generated signal is almost purely non-resonant. The negative delay spectrum (non-resonant signal) can now be used as reference instead of an external measurement in a non-resonant sample. The normalized spectrum needed for further analysis can be simply acquired by changing the probe delay Δt. The non-resonant INR-reference (internal reference) is taken from a resonant sample at the exact same position and under the same conditions (beam path, laser, etc.) as the actual measurement so that artifacts are cancelled out.

The method and the system described in this specification may be applicable for biochemical and structural characterization of a target of interest of a living subject, particularly for invasive and non-invasive evaluation of the biochemical compositions of a target of interest of a living subject and applications of the same. The method and the system described in this specification may be applicable for all kinds of samples, also simpler samples like solutions independent of biochemistry.

In this specification, a method is disclosed that comprises: acquiring first CARS spectrum by Stokes light, Pump light and Probe light; and acquiring second CARS spectrum as a reference to the first CARS spectrum by Stokes light, Pump light and Probe light only varying temporal relationships between Stokes light and Pump light, and Probe light. The first CARS spectrum may include resonance and non-resonance constituents, and the second CARS spectrum may include almost non-resonance constituents, and the method may further comprise acquiring third CARS spectrum including resonance constituents by the first CARS spectrum and the second CARS spectrum. The acquiring first CARS spectrum may include emitting Stokes light and Pump light and Probe light that has a pulse width larger than that of Stokes light and Pump light, in a first relative temporal relationship to overlap within the pulse width of Prob light. The acquiring second CARS spectrum may include emitting Stokes light and Pump light and Probe light in a second relative temporal relationship with a delay relative to the first relative temporal relationship to overlap within the pulse width of Probe light. The acquiring first CARS spectrum may include emitting Stokes light and Pump light and Probe light that has a pulse width larger than that of Stokes light and Pump light, at effectively a same time. The acquiring second CARS spectrum may include emitting Stokes light and Pump light at effectively an end of the pulse width of Probe light.

In this specification, a method is also disclosed. The method comprises: acquiring sets of CARS spectrum by Stokes light, Pump light and Probe light that has a pulse width larger than that of Stokes light and Pump light, just varying temporal relationship between Stokes light and Pump light, and Probe light to overlap within the pulse width of Probe light; and acquiring target CARS spectrum by comparing the sets of CARS spectrum acquired.

A system is also disclosed in this specification. The system comprises: a first optical path configured to supply first light pulses with a first range of wavelengths; a second optical path configured to supply second light pulses with a second range of wavelengths shorter than the first range of wavelengths; a third optical path configured to supply third light pulses with a third range of wavelengths shorter than the second range of wavelengths and a pulse width larger than that of the first light pulses and the second light pulses; an optical I/O unit configured to emit the first light pulses, the second light pulses and the third light pulses to a target and acquire a light from the target to detect sets of CARS spectrum from the target by a detector; a first modulating unit configured to vary relative temporal relationships of the third light pulses to the first light pulses and the second light pulses within the pulse width of the third light pulses; and an analyzer configured to acquire a target CARS spectrum refereeing to the sets of CARS spectrum acquired with different relative temporal relationships of the third light pulses to the first light pulses and the second light pulses. The sets of CARS spectrum may include first CARS spectrum acquired by emitting the first light pulses and the second light pulses and the third light pulses at effectively a same time, and second CARS spectrum acquired by emitting the first light pulses and the second light pulses at effectively an end of the pulse width of Probe light.

In this specification a computer program (program product) for a computer to operate a device is disclosed. The device comprises: a first optical path configured to supply first light pulses with a first range of wavelengths; a second optical path configured to supply second light pulses with a second range of wavelengths shorter than the first range of wavelengths; a third optical path configured to supply third light pulses with a third range of wavelengths shorter than the second range of wavelengths and a pulse width larger than that of the first light pulses and the second light pulses; an optical I/O unit configured to emit the first light pulses, the second light pulses and the third light pulses to a target and acquire a light from the target to detect sets of CARS spectrum from the target by a detector. The computer program includes executable codes for performing steps of acquiring a target CARS spectrum refereeing to the sets of CARS spectrum acquired with different relative temporal relationships of the third light pulses to the first light pulses and the second light pulses.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

1. A method comprising:
acquiring first CARS spectrum by irradiating a part of a target with pulses of Stokes light and pump light, and pulses of probe light with pulse widths larger than pulse widths of the pulses of the Stokes light and the pump light, the Stokes light and the pump light being irradiated within the pulse width of the probe light; and
acquiring second CARS spectrum as a reference to the first CARS spectrum by irradiating the part of the target with the pulses of the Stokes light, the pump light, and the probe light under same condition only varying temporal relationships between the pulses of the Stokes light and the pump light, and the pulses of the probe light to extract resonance constituents from the first CARS spectrum.

2. The method according to claim 1, wherein the acquiring first CARS spectrum includes emitting the pulses of the probe light with a first relative temporal relationship to the pulses of the Stokes light and the pump light to overlap within the pulse width of the pulses of the probe light, and
the acquiring second CARS spectrum includes emitting the pulses of the probe light with a second relative temporal relationship, which has a negative delay relative to the first relative temporal relationship, to the pulses of the Stokes light and the pump light to overlap within the pulse width of the pluses of the probe light.

3. The method according to claim 1, wherein the acquiring second CARS spectrum includes emitting the pulses of the probe light earlier than the pulses of Stokes light and the pump light.

4. The method according to claim 3, wherein the acquiring first CARS spectrum includes emitting the pulses of the Stokes light, the pump light and the probe light at effectively a same time, and
the acquiring second CARS spectrum includes emitting the pulses of the Stokes light and the pump light at effectively an end of the pulse width the pulses of the probe light.

5. The method according to claim 1, further comprising scanning the target with the Stokes light, the pump light, and the probe light to acquire the first CARS spectrum and the second CARS spectrum at each pixel.

6. The method according to claim 1, further comprising scanning the target with the Stokes light, the pump light, and the probe light in three dimensions to acquire the first CARS spectrum and the second CARS spectrum at each voxel.

7. A method comprising:
acquiring sets of CARS spectrum by irradiating a part of a target with pulses of Stokes light and pump light, and pulses of probe light with pulse widths larger than pulse widths of the pulses of the Stokes light and the pump light, just varying temporal relationship between the pulses of the Stokes light and the pump light, and the pulses of the probe light to overlap within the pulse widths of the pulses of the probe light; and
extracting resonance constituents by comparing the sets of CARS spectrum acquired.

8. The method according to claim 7, wherein the acquiring sets of CARS spectrum includes irradiating the part of the target with the pulses of the probe light with a negative delay to the pulses of the Stokes light and the pump light.

9. The method according to claim 7, further comprising scanning the target with the Stokes light, the pump light, and the probe light to acquire the sets of CARS spectrum at each pixel.

10. The method according to claim 7, further comprising scanning the target with the Stokes light, the pump light, and the probe light in three dimensions to acquire the sets of CARS spectrum at each voxel.

11. The method according to claim 1, wherein the pulses of the Stokes light and the pump light have femtosecond-order pulse widths and the pulses of the probe light have picosecond-order pulse widths.

12. The method according to claim 1, wherein the Stokes light has a first range of wavelengths, the pump light has a second range of wavelengths that is shorter than the first range of wavelengths, and the probe light has a third range of the wavelengths that is shorter than the second range of wavelengths.

13. The method according to claim 1, wherein the Stokes light has a broadband Stokes beam.

14. A system comprising:
an optical path configured to irradiate a part of a target with pulses of Stokes light and pump light, and pulses of probe light with pulse widths larger than pulse widths of the pulses of the Stokes light and the pump light;
a modulator configured to control relative temporal relationships between the pulses of the probe light and the pulses of the Stokes light and the pump light within the pulse width of the probe light; and
a detector configured to detect CARS spectrum generated by the pulses of the Stokes light, the pump light, and the probe light to acquire sets of CARS spectrum in association with the relative temporal relationships.

15. The system according to claim 14, wherein the modulator is further configured to control the relative temporal relationships to irradiate the target with the pulses of the probe light with a negative delay to the pulses of the Stokes light and the pump light.

16. The system according to claim 14, wherein the modulator is further configured to control the relative temporal relationships to emit the pulses of the probe light earlier than the pulses of Stokes light and the pump light.

17. The system according to claim 16, wherein the modulator is further configured to control the relative temporal relationships to generate the sets of CARS spectrum that includes a first CARS spectrum acquired by emitting the pulses of the Stokes light, the pump light, and the probe light at effectively a same time, and a second CARS spectrum acquired by emitting the pulses of the Stokes light and the pump light at effectively an end of the pulse width of the probe light.

18. The system according to claim 14, further comprising a scanner that is configured to scan the target with the Stokes light, the pump light, and the probe light to acquire the sets of CARS spectrum at each pixel.

19. The system according to claim 14, further comprising a scanner that is configured to scan the target with the Stokes light, the pump light, and the probe light in three dimensions to acquire the sets of CARS spectrum at each voxel.

20. A computer program for a computer to operate the system according to claim 14, wherein the computer program includes an instruction for controlling the relative temporal relationships to irradiate the target with the pulses of the probe light with a negative delay to the pulses of the Stokes light and the pump light.
